(19) United States
(12) Patent Application Publication
(10) Pub. No.: US 2026/0366952 A1
(43) Pub. Date: Nov. 19, 2026

(54) METHOD AND SYSTEM FOR MEASURING SPRING BACK FOR ELECTRIC CONVERTER

(71) Applicant: Ford Motor Company, Dearborn, MI (US)

(72) Inventors: Sarah Dziadzio, Livonia, MI (US); Alexander Marrocco, Windsor (CA); Nick Sochacki, Ann Arbor, MI (US); Madelyn Frame, Southfield, MI (US); James Cederstrom, Saint Clair Shores, MI (US)

(73) Assignee: Ford Motor Company, Dearborn, MI (US)

(21) Appl. No.: 19/209,179

(22) Filed: May 15, 2025

(51) Int. Cl. G01M 5/00

(52) U.S. Cl. CPC G01M 5/0075

(57) ABSTRACT

A method that includes applying a first load to an assembly including a core shaft and a stack of rotor cores, measuring a first distance of the core shaft relative to the stack of rotor cores at the applied first load, applying a second load to the assembly, measuring a second distance of the core shaft relative to the stack of rotor cores at the applied second load, and determining a spring back value based on the measured first distance and the measured second distance.

### FIELD

The present disclosure relates to a method and system for measuring spring back for an electric converter.

### BACKGROUND

The statements in this section merely provide background information related to the present disclosure and may not constitute prior art.

With the continuing electrification trend in motor vehicles, related components such as electric motors for electric vehicle powertrains are being developed for high volume production. These electric motors are complex assemblies, typically including a stack of rotor cores fixed to a shaft. Assembly of these electric motors can be time consuming and challenging given the complexity of the design of the rotor cores and their embedded magnets. Further, joining the stack of rotor cores to the shaft while achieving assembly efficiency for high volume production can be difficult.

These issues related to the manufacture of electric motors, including joining the stack of rotor cores to the shaft, are addressed by the present disclosure.

### SUMMARY

This section provides a general summary of the disclosure and is not a comprehensive disclosure of its full scope or all of its features.

In one form, the present disclosure discloses a method that includes applying a first load to an assembly comprising a core shaft and a stack of rotor cores, measuring a first distance of the core shaft relative to the stack of rotor cores at the applied first load, applying a second load to the assembly, measuring a second distance of the core shaft relative to the stack of rotor cores at the applied second load, and determining a spring back value based on the measured first distance and the measured second distance.

In variations of the method of the above paragraph, which can be implemented individually or in any combination: the first load is greater than the second load; the first load is released from the assembly prior to applying the second load to the assembly; the method further includes heating the core shaft prior to applying the first load to the assembly to join the stack of rotor cores and the core shaft; the method further includes comparing the spring back value to a predetermined threshold and generating an output signal in response to the spring back value being above the predetermined threshold value; the first load applied to the assembly is held for a first predetermined time period, the second load applied to the assembly is held for a second predetermined time period; wherein the first predetermined time period is greater than the second predetermined time period; the core shaft is cooled prior to being inserted into the aperture of the stack of rotor cores so that a diameter of the aperture of the stack of rotor cores is greater than a diameter of the core shaft; the first measured distance is a first vertical distance between the core shaft and the stack of rotor cores, the second measured distance is a second vertical distance between the core shaft and the stack of rotor cores; and inserting a core shaft into an aperture of a stack of rotor cores to form an assembly.

In another form, the present disclosure discloses a method that includes inserting a core shaft into an aperture of a stack of rotor cores to form an assembly, applying a first load to the assembly, measuring a first distance of the core shaft relative to the stack of rotor cores at the applied first load, applying a second load to the assembly, measuring a second distance of the core shaft relative to the stack of rotor cores at the applied second load, determining a spring back value based on the measured first distance and the measured second distance and generating an output signal in response to the spring back value being above a predetermined threshold value. The first load is greater than the second load.

In variations of the method of the above paragraph, which can be implemented individually or in any combination: the first load is released from the assembly prior to applying the second load to the assembly; the method further includes heating the core shaft prior to applying the first load to the assembly to join the stack of rotor cores and the core shaft; the first load applied to the assembly is held for a first predetermined time period, the second load applied to the assembly is held for a second predetermined time period; the first predetermined time period is greater than the second predetermined time period; the core shaft is cooled prior to being inserted into the aperture of the stack of rotor cores so that a diameter of the aperture of the stack of rotor cores is greater than a diameter of the core shaft; and the first measured distance is a first vertical distance between the core shaft and the stack of rotor cores, the second measured distance is a second vertical distance between the core shaft and the stack of rotor cores.

In another form, the present disclosure discloses a system that includes a load applicator and a controller. The load applicator is configured to engage and move the core shaft. The controller is in communication with the load applicator and configured to: instruct the load applicator to apply a first load to an assembly comprising a core shaft and a stack of rotor cores, measure a first distance of the core shaft relative to the stack of rotor cores at the applied first load, instruct the load applicator to apply a second load to the assembly, measure a second distance of the core shaft relative to the stack of rotor cores at the applied second load, and determine a spring back value based on the measured first distance and the measured second distance.

In variations of the system of the above paragraph, which can be implemented individually or in any combination: the first load is greater than the second load; the first load is released from the assembly prior to applying the second load to the assembly; the controller is configured instruct the load applicator to insert the core shaft into an aperture of the stack of rotor cores to form the assembly; and the system further including a heater in communication with the controller, the controller configured to turn on the heater in response to the load applicator inserting the core shaft into the aperture of the stack of rotor cores to join the stack of rotor cores and the core shaft.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1A is a perspective view of an electric converter including a stack of rotor cores and a shaft assembled according to the teachings of the present disclosure;

FIG. 1B is a perspective view of the stack of rotor cores of the electric converter of FIG. 1A;

FIG. 1C is a perspective view of the shaft of the electric converter of FIG. 1A;

FIG. 2 is a schematic view of a system for assembling the stack of rotor cores and the shaft of FIG. 1;

FIG. 3 is an exploded view of a heater of the system of FIG. 2;

FIG. 4 is a perspective view of the heater of the system of FIG. 2;

FIG. 5 is a perspective view of the alignment shaft of the system of FIG. 2;

FIG. 6A is a schematic view of a stack of heated rotor cores being placed on a base plate of the system of FIG. 2;

FIG. 6B is a schematic view of the base plate containing the stack of heated rotor cores being moved from a first position to a second position;

FIG. 6C is a schematic view of a cooled shaft being inserted into the stack of heated rotor cores;

FIG. 6D is a schematic view of the heater of FIG. 3 heating the cooled shaft to join the stack of heated rotor cores and the heated shaft;

FIG. 7 is a functional block diagram of the system for assembling the stack of rotor cores of the electric converter to the shaft of the electric converter according to the principles of the present disclosure;

FIGS. 8A-8D are schematic views of the assembled electric converter undergoing testing for spring back according to the principles of the present disclosure; and

FIG. 9 is a flow diagram illustrating a method of testing spring back of the assembled electric converter according to the principles of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

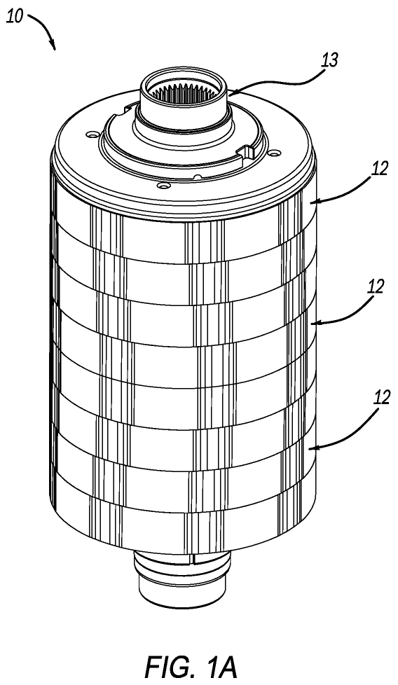

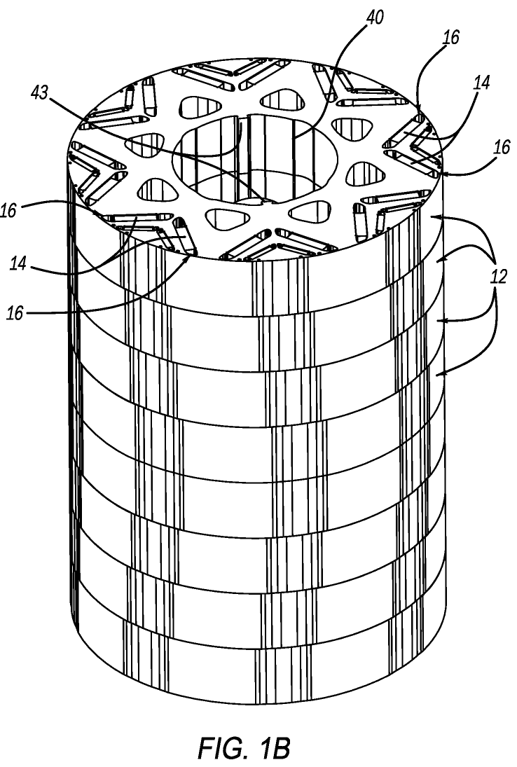

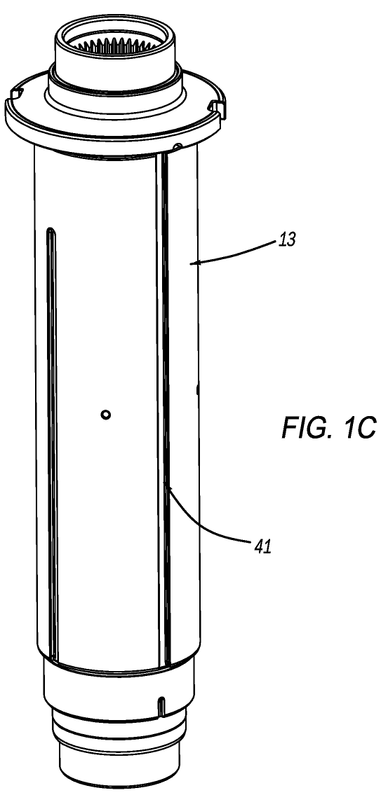

With reference to FIGS. 1A-1C, an electric converter or assembly is provided and is generally indicated by reference numeral 10. The electric converter 10 includes a stack of rotor cores 12 (FIGS. 1A and 1B) and a core shaft or shaft 13 (FIGS. 1A and 1C). The stack of rotor cores 12 may include a plurality of magnetizable inserts 14 disposed within cavities 16 of the rotor cores 12 (FIG. 1B). The cavities 16 of each rotor core 12 are circumferentially spaced apart around the rotor core 12 and are in fluid communication with the cavities 16 of other rotor cores 12 of the stack of rotor cores 12. For example, the cavities 16 of one of the rotor cores 12 are in fluid communication with the cavities 16 of an adjacent rotor core 12. In this way, the cavities 16 of the rotor cores 12 are in fluid communication with each other along an axial direction of the electric converter 10 such that adhesive material can flow through each of the cavities 16 during a molding process. Each rotor core 12 may be formed by a stack of laminations (not specifically shown) secured to each other. An example construction of an electric converter including the rotor cores is described in detail in U.S. Publication No. 2018/0287439, which has been incorporated herein by reference in its entirety. One example construction of an electric converter undergoing the molding process to secure the magnetizable inserts 14 to the rotor cores is disclosed in Applicant’s co-pending Application No. 18/673,217 which is commonly owned with the present application and the contents of which are incorporated herein by reference in its entirety.

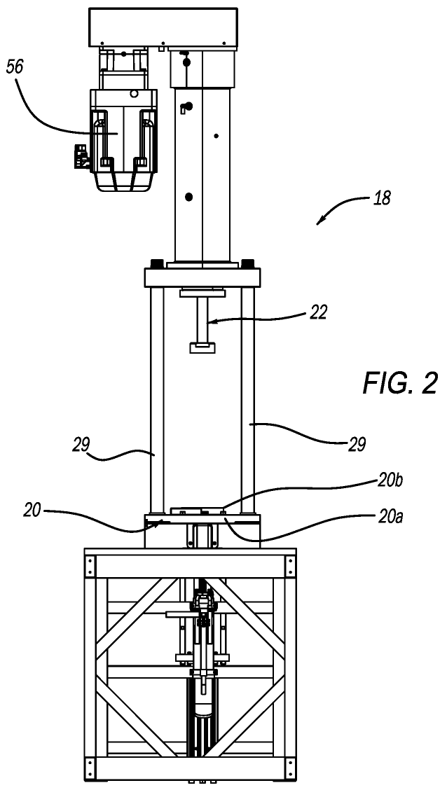

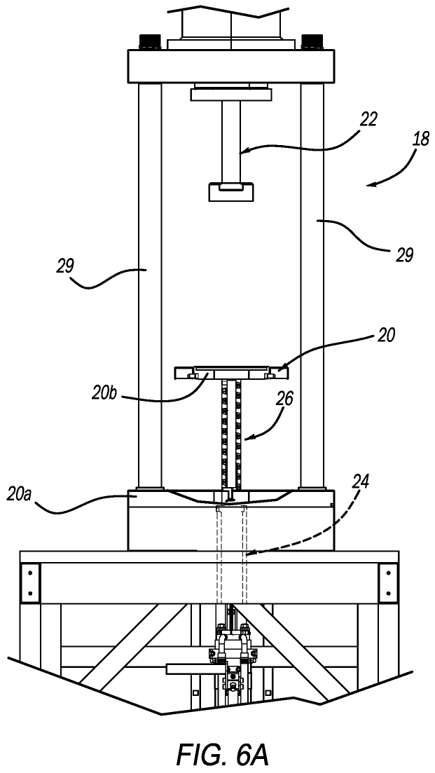

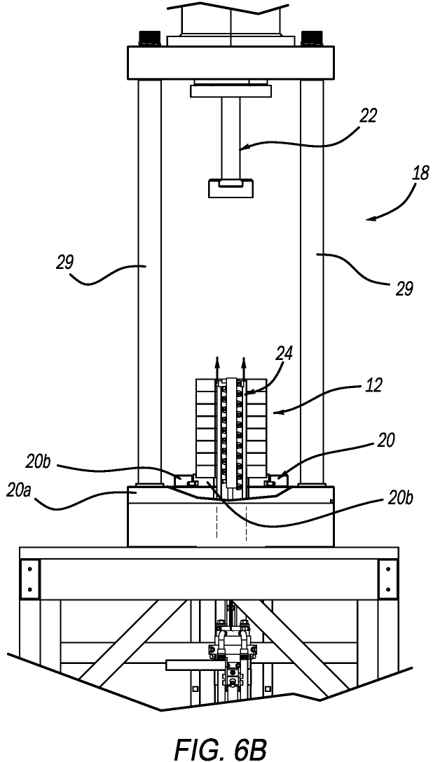

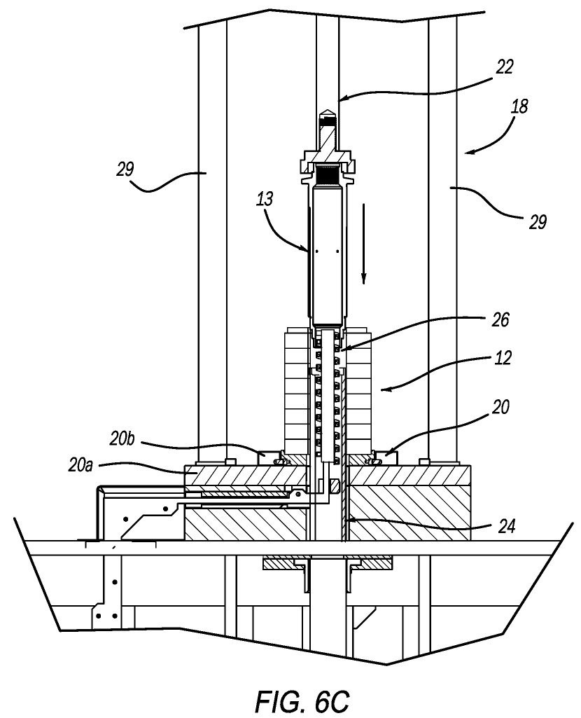

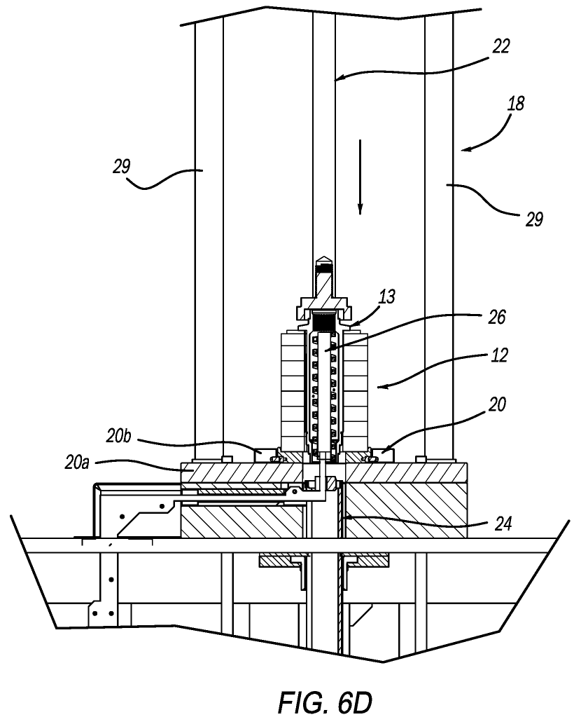

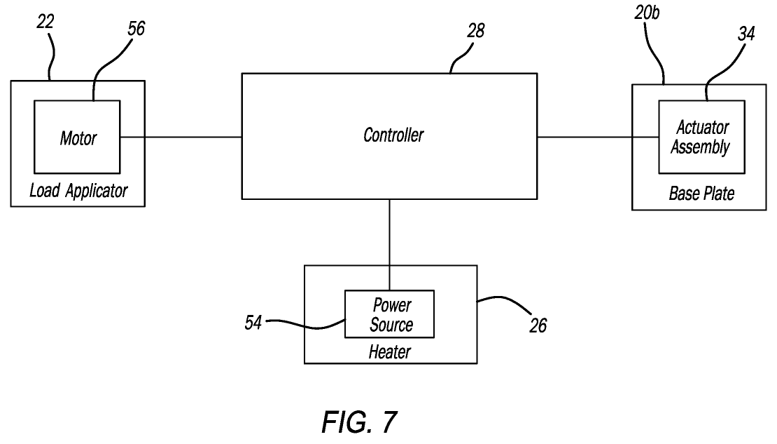

With reference to FIGS. 2 and 6A-6D, a system or tool assembly 18 for joining the stack of rotor cores 12 and the shaft 13 is provided. The stack of rotor cores 12 and the shaft 13 may be joined together using the system 18 after the stack of rotor cores 12 undergoes the molding process. That is, the stack of rotor cores 12 and the shaft 13 are joined together such that the stack of rotor cores 12 and the shaft 13 are fixed to each other (e.g., axially and rotationally fixed to each other). In one example, the stack of rotor cores 12 and the shaft 13 are joined together using an interference fit or shrink fit. The system 18 includes a base assembly 20, a load applicator 22, an alignment shaft 24, a heating assembly or heater 26, and a controller 28 (FIG. 7).

The base assembly 20 includes a support structure 20a and a base plate 20b. The support structure 20a is stationary (i.e., does not move) and may be fixed to one or more beams 29 of the system 18. The base plate 20b supports the stack of rotor cores 12 as will be described in more detail below and is movable, via an actuator assembly 34, between a first position (FIG. 6A) in which the base plate 20b is removed from the support structure 20a and a second position (FIGS. 2 and 6B-6D) in which the base plate 20b engages or abuts the support structure 20a. Example details regarding the support structure 20a and the base plate 20b are disclosed in U.S. Patent App. No. 18/802,765, and titled "METHOD AND SYSTEM FOR ASSEMBLING AN ELECTRIC CONVERTER," which is commonly owned with the present application and the contents of which are incorporated herein by reference in its entirety.

The load applicator 22 is removably coupled to the shaft 13 and moves the shaft 13 between a first position (FIG. 6C) in which the shaft 13 is removed from the stack of rotor cores 12 (i.e., removed from an aperture 40 of the stack of rotor cores 12) and a second position (FIG. 6D) in which the shaft 13 is inserted into the aperture 40 of the stack of rotor cores 12. When the load applicator 22 is in the second position, the shaft 13 surrounds the heater 26. The load applicator 22 is removably secured to the shaft 13 such that the load applicator 22 may be detached or disconnected from the shaft 13 when the load applicator 22 is in the first position or second position. In one form, the load applicator 22 may be a press that is allowed to apply a load to the shaft 13 and the stack of rotor cores 12 as will be described in more detail below.

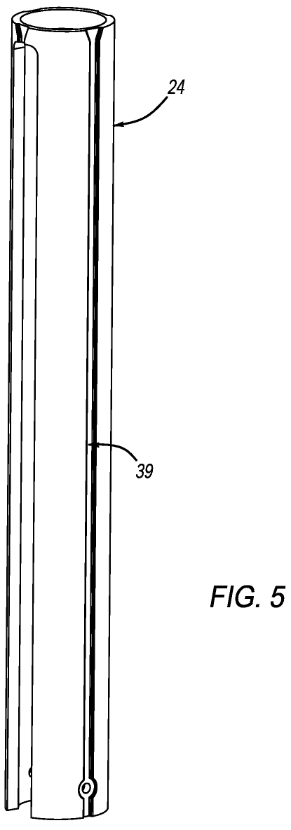

With reference to FIGS. 5 and 6A-6D, the alignment shaft 24 aligns the stack of rotor cores 12 and the shaft 13 to each other. That is, the inner periphery of the stack of rotor cores 12 may include protrusions 43 (FIG. 1B) that are received in keyways 39 (FIG. 5; e.g., grooves) of the alignment shaft 24 when the alignment shaft 24 is in the first state (FIG. 6B). In this way, the alignment shaft 24 rotationally aligns the stack of rotor cores 12 such that the protrusions of the stack of rotor cores 12 are received in keyways 41 (FIG. 1C; e.g., grooves) of the shaft 13 as the load applicator 22 is moved toward the second position and the alignment shaft 24 is moved toward the second state (FIG. 6D). In the example illustrated, the alignment shaft 24 is hollow and is also coaxial with the shaft 13 and the stack of rotor cores 12.

The alignment shaft 24 is movable between the first state (FIG. 6B) in which the alignment shaft 24 is inserted into the aperture 40 and surrounds the heater 26 and a second state (FIG. 6D) in which the alignment shaft 24 is removed from the heater 26 (i.e., separated from and not surrounding the heater 26). When in the second state, the alignment shaft 24 is removed from the aperture 40 in the stack of rotor cores 12. The alignment shaft 24 may be movable between the first state and the second state via an actuator such that the protrusions 43 of the stack of rotor cores 12 are removed from the keyways 39 of the alignment shaft 24 and are received in the keyways 41 of the shaft 13 as the load applicator 22 is moved toward the second position and the alignment shaft 24 is moved toward the second state. In this way, the shaft 13 is rotationally aligned with the stack of rotor cores 12 prior to being joined to the stack of rotor cores 12. Example details regarding the alignment shaft 24 is disclosed in U.S. Patent App. No. 18/802,765, and titled "METHOD AND SYSTEM FOR ASSEMBLING AN ELECTRIC CONVERTER," which is commonly owned with the present application and the contents of which are incorporated herein by reference in its entirety.

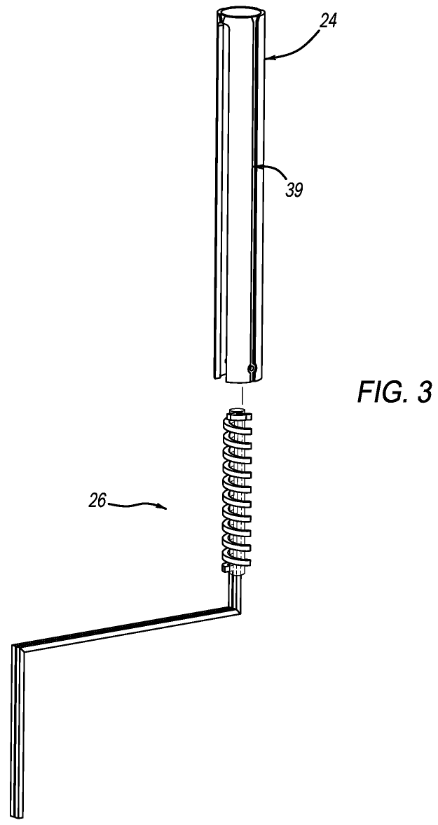

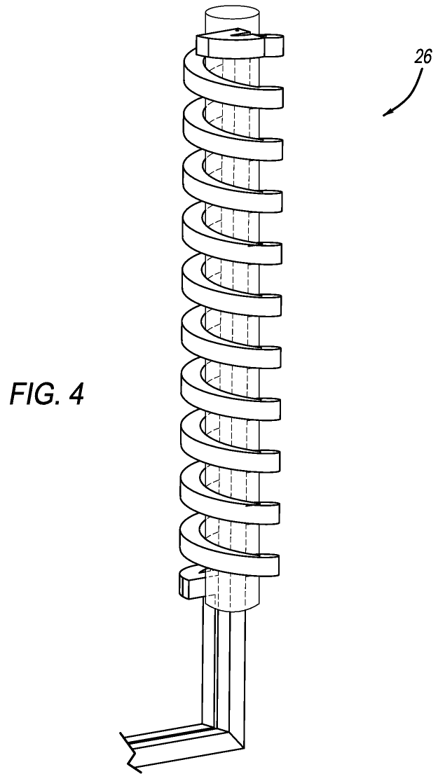

With reference to FIGS. 3, 4, 6C and 6D, the heater 26 extends through the central opening of the support structure 20a and is spaced apart from the base assembly 20. The heater 26 is also disposed in the alignment shaft 24 when the alignment shaft 24 is in the first state, disposed in the stack of rotor cores 12 when the stack of rotor cores 12 are placed on the base assembly 20 and the base assembly 20 is in the second position, and disposed in the shaft 13 when the shaft 13 is inserted into the stack of rotor cores 12. The heater 26 is in a heat transfer relationship with the shaft 13 once the shaft 13 is inserted into the stack of rotor cores 12. In this way, the heating assembly 26 may heat the shaft 13 to facilitate joining of the shaft 13 and the stack of rotor cores 12 to each other as will be described in more detail below. In the example illustrated, the heater 26 is spaced apart from the shaft 13 when the shaft 13 is inserted into the stack of rotor cores 12 such that the heater assembly 26 heats the shaft 13 using radiation or convection, for example. In another example, the heater 26 may contact the shaft 13 to heat the shaft using conduction. Example details regarding the heater 26 is disclosed in U.S. Patent App. No. 18/802,765, and titled "METHOD AND SYSTEM FOR ASSEMBLING AN ELECTRIC CONVERTER," which is commonly owned with the present application and the contents of which are incorporated herein by reference in its entirety.

With reference to FIG. 7, the controller 28 is in communication with a motor 56 of the load applicator 22, the power source 54 of the heater 26, and the actuator assembly 34 of the base plate 20b, and may monitor and control operations of the motor 56, the power source 54 and the actuator assembly 34 based on data received. That is, the controller 28 may instruct the load applicator 22 to move between the first and second positions and instruct the base plate to move between the first and second positions. The controller 28 may also control the current supplied to the coils (not shown), which controls the heat generated by the heater 26. In one example, the controller 28 is in communication with the load applicator 22, the heater 26, and the base plate 20b using a wireless communication protocol (e.g., a Bluetooth®-type protocol, a cellular protocol, a wireless fidelity (Wi-Fi)-type protocol, a near-field communication (NFC) protocol, an ultra-wideband (UWB) protocol, among others). The motor 56 may be an electric motor, a hydraulic motor, or any other suitable motor capable of moving the load applicator 22 between the first position and second position. An example control algorithm for assembling the stack of rotor cores 12 to the shaft 13 using the system 18 is disclosed in U.S. Patent App. No. 18/802,765, and titled "METHOD AND SYSTEM FOR ASSEMBLING AN ELECTRIC CONVERTER."

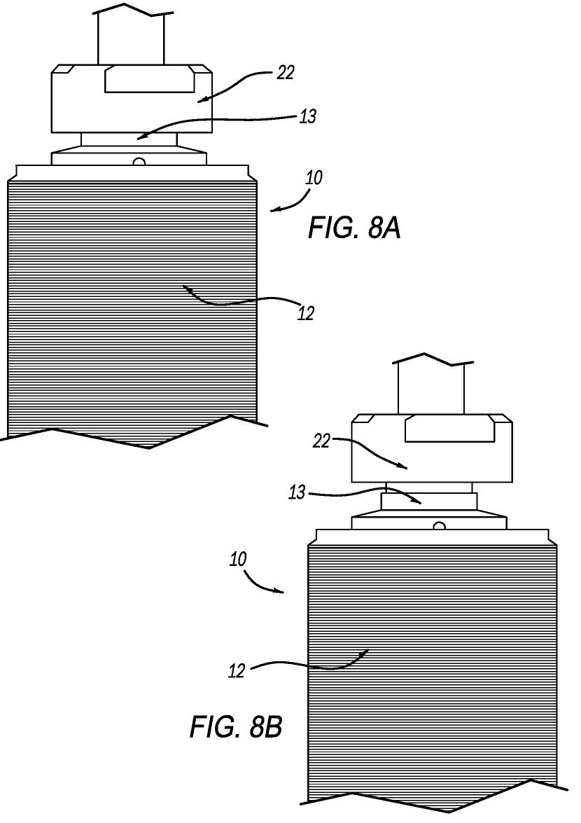

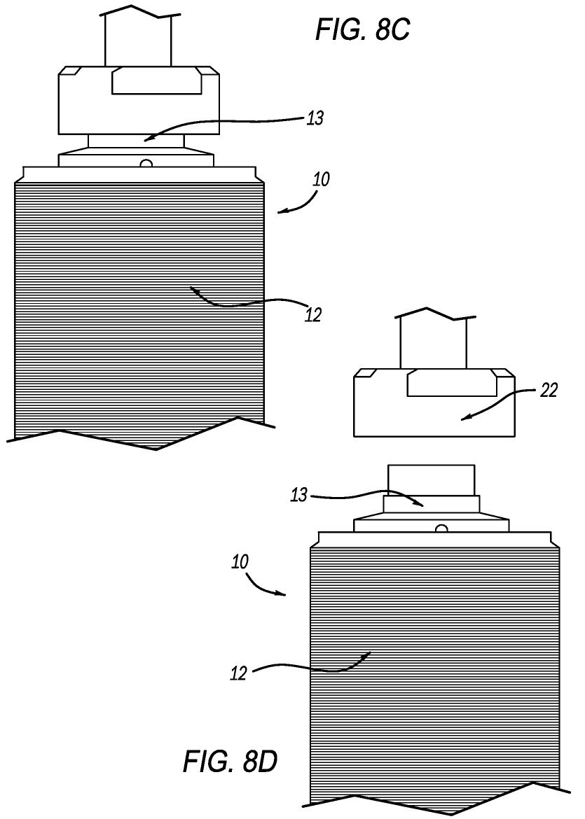

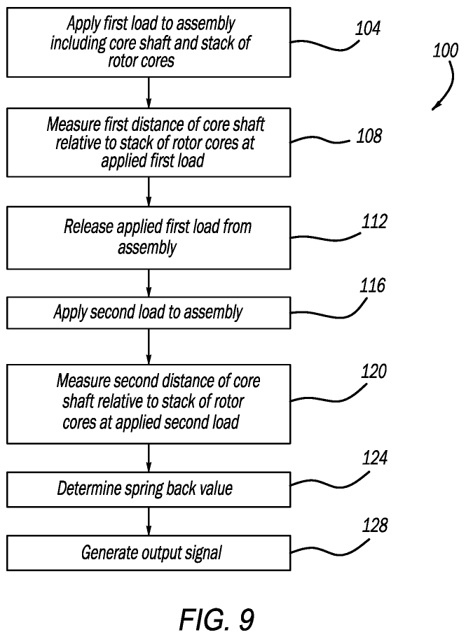

With reference to FIGS. 8A-8D and 9, an example control algorithm 100 for measuring spring back in the assembled electric converter 10 (i.e., assembly) is illustrated. That is, the stack of rotor cores 12 and the shaft 13 may be assembled as described above using the system 18. Spring back of the assembly may then be measured to determine whether proper joining (i.e., seizing) of the stack of rotor cores 12 and the shaft 13 has been achieved. At 104, the control algorithm, using the controller 28, instructs the load applicator 22 to apply a first load to the assembly 10 comprising the joined core shaft 13 and the stack of rotor cores 12 (FIG. 8A). In the example illustrated, the assembly 10 is secured base assembly 20 and the first load is an axial load applied to the axial end of the assembly 10 (e.g., an axial end of the core shaft 13 of the assembly 10). In some forms, the assembly 10 may be moved from the base assembly 20 to another workstation (not shown) where the first load is applied.

At 108, the control algorithm, using the controller 28, measures a first distance of the core shaft 13 relative to the stack of rotor cores 12 at the applied first load. In the example illustrated, the first distance is measured using the press depth of the load applicator 22 when it touches the assembly 10. In other forms, the assembly 10 may include a sensor unit associated with the assembly 10 (e.g., disposed on the core shaft 13 and/or the stack of rotor cores 12) that measures a distance between a first location of the core shaft 13 and a second location of the stack of rotor cores 12 at the applied first load.

At 112, the control algorithm, using the controller 28, instructs the load applicator to release the first load applied to the assembly 10 (FIG. 8B). At 116, the control algorithm, using the controller 28, instructs the load applicator 22 to apply a second load to the assembly 10 comprising the joined core shaft 13 and the stack of rotor cores 12 (FIG. 8C). The first load applied to the assembly 10 may be greater than the second load. For example, the first load applied to the assembly 10 may be 100 kilonewtons (kN) and the second load applied to the assembly 10 may be 10 kilonewtons (kN). It should also be understood that the first and second applied loads may be held for a predetermined time period. That is, the first load applied to the assembly 10 may be held for a first predetermined time period and the second load applied to the assembly 10 may be held for a second predetermined time period. In one form, the first predetermined time period is greater than the second predetermined time period. In another form, the first predetermined time period is equal to or less than the second predetermined time period.

At 120, the control algorithm, using the controller 28, measures a second distance of the core shaft 13 relative to the stack of rotor cores 12 at the applied second load. In the example illustrated, the second distance is measured using the press depth of the load applicator 22. In other forms, the assembly 10 may include the sensor unit (not shown) associated with the assembly 10 (e.g., disposed on the core shaft 13 and/or the stack of rotor cores 12) that measures a distance between the first location of the core shaft 13 and the second location of the stack of rotor cores 12 at the applied first load.

At 124, the control algorithm, using the controller 28, determines a spring back value based on the measured first distance and the measured second distance. The spring back value may be determined by taking the difference between the measured first distance and the measured second distance. That is, the core shaft 13 may move upward (i.e., spring back) along a longitudinal direction relative to the stack of rotor cores 12 at the applied loads. The first measured distance is a first longitudinal distance (i.e., vertical) between the core shaft 13 and the stack of rotor cores 12 and the second measured distance is a second longitudinal distance (i.e., vertical) between the core shaft 13 and the stack of rotor cores 12.

At 128, the control algorithm, using the controller 28, generates an output signal in response to the spring back value being above a predetermined threshold value. In one form, the predetermined threshold value is 1.25 millimeters (mm). In another form, the predetermined threshold value may be greater than or less than 1.25mm. It should be understood that the generated output signal may be a signal notifying an operator to discard the assembly for having a spring back value over the predetermined threshold value. The load applicator 22 is removed from the assembly 10 (FIG. 8D) such that a new assembly may be loaded onto the base assembly 20 and the process repeated.

The system and method of the present disclosure provides the benefit of determining whether sufficient friction between the joined core shaft 13 and the stack of rotor cores 12 has been achieved. This can be done in a nondestructive matter, which provides the benefit of testing each assembly joined using the system 10 disclosed herein.

Unless otherwise expressly indicated herein, all numerical values indicating mechanical/thermal properties, compositional percentages, dimensions and/or tolerances, or other characteristics are to be understood as modified by the word “about” or "approximately" in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

In this application, the term “controller” and/or “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The term memory is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A method comprising:
applying a first load to an assembly comprising a core shaft and a stack of rotor cores;
measuring a first distance of the core shaft relative to the stack of rotor cores at the applied first load;
applying a second load to the assembly;
measuring a second distance of the core shaft relative to the stack of rotor cores at the applied second load; and
determining a spring back value based on the measured first distance and the measured second distance.

2. The method of claim 1, wherein the first load is greater than the second load.

3. The method of claim 1, wherein the first load is released from the assembly prior to applying the second load to the assembly.

4. The method of claim 1, further comprising:
inserting the core shaft into an aperture of the stack of rotor cores prior to applying the first load; and
heating the core shaft prior to applying the first load to the assembly to join the stack of rotor cores and the core shaft.

5. The method of claim 1, further comprising:
comparing the spring back value to a predetermined threshold; and
generating an output signal in response to the spring back value being above the predetermined threshold value.

6. The method of claim 1, wherein the first load applied to the assembly is held for a first predetermined time period, and wherein the second load applied to the assembly is held for a second predetermined time period.

7. The method of claim 6, wherein the first predetermined time period is greater than the second predetermined time period.

8. The method of claim 1, further comprising inserting the core shaft into an aperture of the stack of rotor cores prior to applying the first load, the core shaft is cooled prior to being inserted into the aperture of the stack of rotor cores so that a diameter of the aperture of the stack of rotor cores is greater than a diameter of the core shaft.

9. The method of claim 1, wherein the first measured distance is a first vertical distance between the core shaft and the stack of rotor cores, and wherein the second measured distance is a second vertical distance between the core shaft and the stack of rotor cores.

10. A method comprising:
inserting a core shaft into an aperture of a stack of rotor cores, the core shaft and the stack of rotor cores forming an assembly;
applying a first load to the assembly;
measuring a first distance of the core shaft relative to the stack of rotor cores at the applied first load;
applying a second load to the assembly, the first load being greater than the second load;
measuring a second distance of the core shaft relative to the stack of rotor cores at the applied second load;
determining a spring back value based on the measured first distance and the measured second distance; and
generating an output signal in response to the spring back value being above a predetermined threshold value.

11. The method of claim 10, wherein the first load is released from the assembly prior to applying the second load to the assembly.

12. The method of claim 10, further comprising heating the core shaft prior to applying the first load to the assembly to join the stack of rotor cores and the core shaft.

13. The method of claim 10, wherein the first load applied to the assembly is held for a first predetermined time period, and wherein the second load applied to the assembly is held for a second predetermined time period.

14. The method of claim 13, wherein the first predetermined time period is greater than the second predetermined time period.

15. The method of claim 10, wherein the core shaft is cooled prior to being inserted into the aperture of the stack of rotor cores so that a diameter of the aperture of the stack of rotor cores is greater than a diameter of the core shaft.

16. The method of claim 10, wherein the first measured distance is a first vertical distance between the core shaft and the stack of rotor cores, and wherein the second measured distance is a second vertical distance between the core shaft and the stack of rotor cores.

17. A system comprising:
a load applicator; and
a controller in communication with the load applicator, the controller configured to:
instruct the load applicator to apply a first load to an assembly comprising a core shaft and a stack of rotor cores;
measure a first distance of the core shaft relative to the stack of rotor cores at the applied first load;
instruct the load applicator to apply a second load to the assembly;
measure a second distance of the core shaft relative to the stack of rotor cores at the applied second load; and
determine a spring back value based on the measured first distance and the measured second distance.

18. The system of claim 17, wherein the first load is greater than the second load.

19. The system of claim 17, wherein the first load is released from the assembly prior to applying the second load to the assembly.

20. The system of claim 17, further comprising a heater in communication with the controller, the controller configured:
instruct the load applicator to insert the core shaft into an aperture of the stack of rotor cores prior to applying the first load to the assembly; and
turn on the heater in response to the load applicator inserting the core shaft into the aperture of the stack of rotor cores to join the stack of rotor cores and the core shaft to form the assembly.
